(19) United States
(12) Patent Application Publication
(10) Pub. No.: US 2006/0036834 A1
(43) Pub. Date: Feb. 16, 2006

(54) Trace reuse

(76) Inventors: Subramaniam Maiyuran, Gold River, CA (US); Peter J. Smith, Folsom, CA (US); Varghese George, Folsom, CA (US); Eran Altshuler, Haifa (IL); Robert Valentine, Qiryat Tivon (IL); Zeev Offen, Haifa (IL); Oded Lempel, Moshav Amikam (IL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/917,582

(22) Filed: Aug. 13, 2004

(51) Int. Cl. G06F 9/30

(52) U.S. Cl. 712/214

(57) ABSTRACT

A trace management architecture to enable the reuse of uops within one or more repeated traces. More particularly, embodiments of the invention relate to a technique to prevent multiple accesses to various functional units within a trace management architecture by reusing traces or sequences of traces that are repeated during a period of operation of the microprocessor, avoiding performance gaps due to multiple trace cache accesses and increasing the rate at which uops can be executed within a processor.

### FIELD

Embodiments of the invention relate to microprocessors and microprocessor systems. More particularly, embodiments of the invention relate to a technique to reuse micro-operations (uops) within a trace cache of a microprocessor under various microprocessor architectural state conditions.

### BACKGROUND

Typical pipelined microprocessors include a storage structure for storing micro-operations (uops) decoded from program instructions, such as a “trace cache”. Uops can be issued, or “streamed”, from the trace cache and accessed by various functional units, such as execution logic in order to perform the instructions with which the uops are associated.

Uops are typically decoded and stored in the trace cache in sequences, known as “traces”. Each trace typically has associated with it a head pointer, to indicate the start of the trace, and a tail pointer, to indicate the end of the trace and where the next trace exists in the trace cache. The uops within each trace are organized, or “built”, as the instructions to which they correspond are decoded within the microprocessor. Accordingly, any branches that may be taken within the trace are predicted during this build process, typically by a branch prediction unit, and the predicted uops are stored within the trace. Furthermore, branches may occur “off trace”, causing uops not previously predicted to be within the trace to be included in a new trace. Furthermore, uops stored in other uop storage structures, such as the micro-sequencer, can be called by uops within the trace, thereby issuing the uops outside of the trace cache as part of another trace.

After the traces are built, they are typically stored in a uop queue for execution. However, in typical prior art microprocessors, traces within recurring segments of code, such as a loop, must be read from the trace cache and stored in the uop queue for each iteration of the recurring trace or traces. This can result in excessive power consumption during periods of high trace iteration, such as in a short loop. Furthermore, because the same sequence of uops is typically executed during each iteration of the recurring trace (i.e. there are few unpredicted branches), processing resources can be used excessively resulting in more power consumption. In addition to power disadvantages, many prior art trace management architectures require repeated accesses to the trace cache, even for repeated traces, thereby incurring performance penalties.

FIG. 1 illustrates a block diagram of a prior art trace management architecture within a microprocessor. Uops are decoded and grouped in sequences (“traces”) within the trace cache (“TC”) array. The TC controller controls the flow of the traces to the uop queue (“UQ”), where the traces are stored for execution by subsequent pipeline stages. The branch prediction logic serves to make branch predictions among the uops before and/or after they are stored in traces within the TC. As predicted branches are sent to the execution, the result of the correct branch direction can update the branch prediction logic to adjust or maintain the prediction for the next time the branch is encountered. Furthermore, the micro-sequencer read-only only memory (“MS ROM”) stores uops that may be called by uops within the TC and therefore be sent to the UQ instead of a uop from the TC.

The trace management of FIG. 1 has no ability to recognize repeated traces and therefore retrieves traces from the TC to store in the UQ each time the trace is needed. Furthermore, the prediction logic of FIG. 1 makes predictions for branches among the uops each time a trace is stored to the UQ, even though the branches may take the same path each time the trace is executed. Accordingly, the TC array and the prediction logic remain active for much of the operation of the trace management architecture of FIG. 1, and in fact become even more active, and use, more power, during recurring trace execution. Therefore, the prior art trace management architecture of FIG. 1 uses more power as the number of times a trace is executed increases, such as when the trace is part of a loop. Even more power can be drawn by the TC and prediction logic in cases in which the traces are executed frequently, as in a short loop.

### BRIEF DESCRIPTION OF THE DRAWINGS

Embodiments of the invention are illustrated by way of example and not limitation in the figures of the accompanying drawings, in which like references indicate similar elements and in which:

FIG. 1 illustrates a prior art trace management architecture used in a microprocessor.

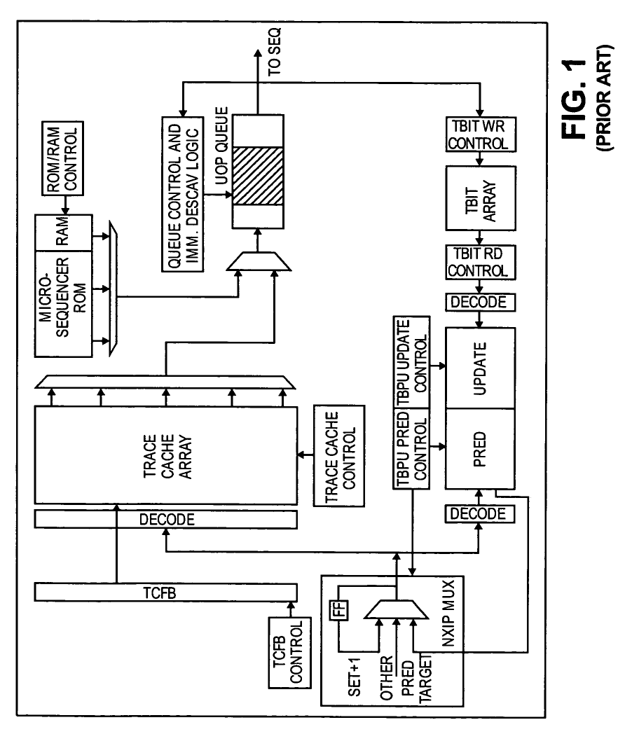

FIG. 2 illustrates a trace management architecture, according to one embodiment of the invention.

FIG. 3 is a flow diagram illustrating the functionality of the trace analyzer, according to one embodiment of the invention.

FIG. 4 is a flow diagram illustrating the transition to and from trace reuse queue stream mode, according to one embodiment of the invention.

FIG. 5 illustrates how trace reuse queue space is managed according to one embodiment of the invention.

FIG. 6 is a flow diagram illustrating the functionality of the trace reuse queue according to one embodiment of the invention.

FIG. 7 is a state diagram illustrating various power states of a trace management architecture, according to one embodiment of the invention.

FIG. 8 shows various aspects of a trace management architecture, according to one embodiment, in which various circuits can be disabled depending on the state of the trace management architecture.

FIG. 9 is a front-side bus computer system block diagram in which at least one embodiment of the invention may be used.

FIG. 10 is a point-to-point computer system block diagram in which at least one embodiment of the invention may be used.

### DETAILED DESCRIPTION

Embodiments of the invention relate to micro-operation (uop) reuse within a microprocessor. More particularly, embodiments of the invention relate to a technique to prevent multiple accesses to various functional units within a trace management architecture by reusing traces or sequences of traces that are repeated during a period of operation of the microprocessor, avoiding performance gaps due to multiple trace cache accesses and increasing the rate at which uops can be executed within a processor.

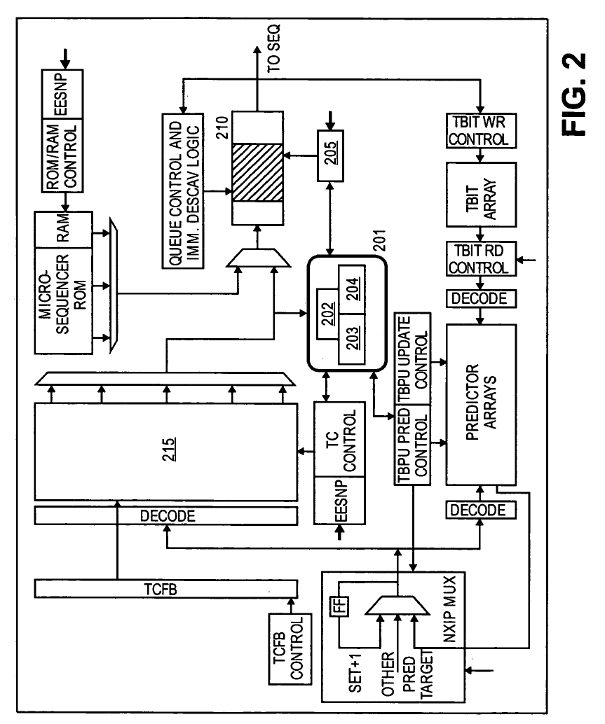

FIG. 2 illustrates a portion of a trace management architecture according to one embodiment of the invention in which a trace analyzer 201 and reuse controller 205 interact to manage allocation of traces within a trace reuse queue (TRQ) 210. In one embodiment, the TRQ may be a separate queue used only for reused traces, whereas in other embodiments the TRQ may be included in a uop queue to store both reused and non-reused traces. In the embodiment illustrated in FIG. 2, the trace analyzer further serves to control access to a trace cache 215 as well as interact with a trace branch prediction control unit 220 to help conserve power during periods of repeated trace execution.

The trace analyzer of FIG. 2, is capable of detecting a repeated trace sequence (RTS) issued from the trace cache and signaling to the reuse controller the start and end of an RTS and the RTS's iteration count. Furthermore, the trace analyzer can enable or disable the trace cache and the prediction control unit in order to conserve power during periods in which an RTS is to be streamed from the TRQ. The reuse controller can control the issuance of RTSs from the TRQ by setting pointer to the appropriate starting point of an RTS for each iteration of the RTS, and then signaling to the trace cache and/or the trace analyzer after the last iteration of the RTS has streamed from the TRQ. Furthermore, the reuse controller can detect stall conditions, in which uops are no longer being executed, and control the flow of uops from the TRQ accordingly.

The RTS detector 202 can, among other things, detect a sequence of uops (“trace”) within the trace that is to be repeated a certain number of times according to some program structure, such as a loop. Typically, a trace contains a code (“pointer”) to indicate the beginning of the trace (“head”) and a code to indicate the end of trace (“tail”). In an RTS, the tail may point to the first uop in the next trace of the RTS, indicated by the next trace head, or the tail may simply point back to the first uop of the trace to which it corresponds. Alternatively, the tail may point to a uop that is different than the uop previously predicted to be in the trace (“off-trace prediction”), such as a uop that was predicted to be outside of the trace, or a uop that exists within some other storage structure, such as a uop sequence read-only memory (ROM) 217.

Because an RTS is always indicated by the last uop of the trace pointing back to the beginning of the trace, the detection of an RTS is simplified in at least one embodiment, by detecting only the last uop of the trace (tail or off-trace uop). Furthermore, the RTS detection can be made in some embodiments by only detecting those uops that branch backward. However, in general any uop within an RTS may be detected to indicate the end of the RTS.

The RTS length calculator 203 can detect the length of the RTS in order to determine whether the RTS will fit in the TRQ and adjust the size of the RTS accordingly. Before an RTS can be stored into the TRQ and continually supplied (“streamed”) to downstream logic, such as a sequencer, throughout the iterations of the loop to which the RTS corresponds, the RTS build checker 204 must verify certain requirements of the RTS, the branch prediction unit, and the particular uops within the RTS. In particular, the trace analyzer must determine the size of the RTS so that the reuse controller can set the pointers within the TRQ to their appropriate respective positions. Furthermore, if the trace is too large for the TRQ, the RTS may not be able to be streamed from the TRQ. There may also be trace build restrictions that must be complied with before the RTS is streamed from the TRQ, such as not allowing scoreboard uops or unmatched call return pairs.

In addition to build requirements, the trace analyzer detects whether certain branch prediction requirements have been met before indicating to the reuse controller to begin streaming uops from the TRQ. In particular, the trace analyzer checks the branch prediction control unit to see if the global branch predictor history limitation has been exceeded (“saturated”). Global branch prediction typically refers to a prediction based on the history of uops or branches prior to a particular branch. For example, in one embodiment, a global entry is updated and a global prediction is made by correlating a past combination of branch predictions to the current branch.

While streaming from an RTS, global predictions may be made over a relatively large number of branches, repeating each prediction during each RTS iteration. Therefore, global branch predictions within the RTS (i.e. those predictions that track branch results as a function of uop sequences or branches that precede them) can be come indeterminate, or “saturated” (the global history prior to entering the RTS is overwritten). In some embodiments, the saturated global prediction control logic can be disabled during RTS streaming in order to conserve power. In addition to the global prediction, a loop prediction can also be made after the global predictor begins to repeat, in one embodiment of the invention. In one embodiment, the loop prediction is a stew-based loop prediction that updates after each RTS iteration. The stew-based loop prediction can predict the repeat of an RTS, such that the RTS can be continuously streamed from the TRQ over and over again until the loop count reaches a maximum value. This allows the trace cache and prediction logic to be disabled in order to conserve power during RTS streaming, as no further accesses to the trace cache or prediction logic are necessary until the maximum loop count is met.

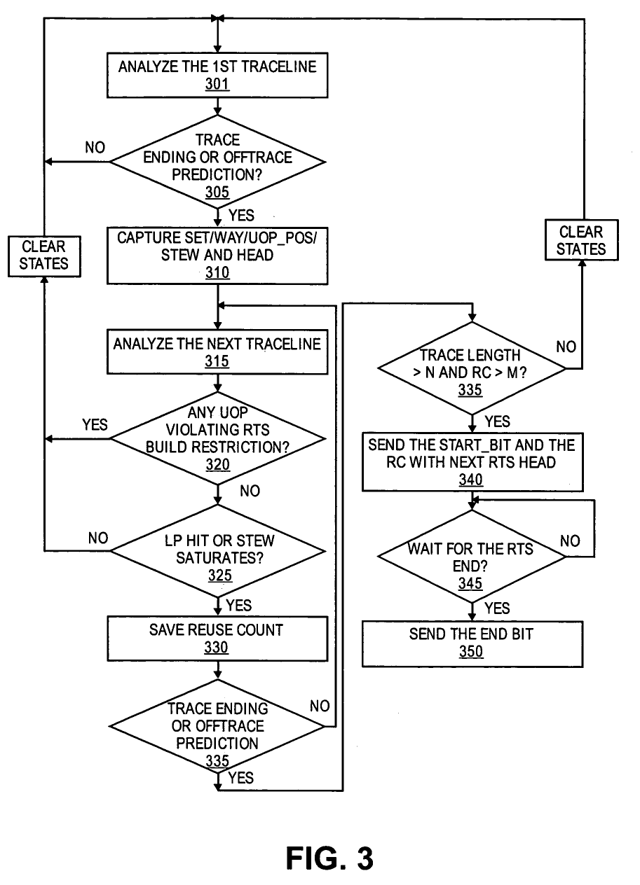

FIG. 3 is a flow diagram illustrating various operations involved in the function of the trace analyzer, according to one embodiment of the invention. Particularly, FIG. 3 illustrates operations involved in detecting an RTS. After a uop within a trace or group of uops within a trace are retrieved from the trace cache at operation 301, if a trace ending code, such as a tail pointer, or an off-trace branch is not detected at operation 305, the next uop or group of uops within the trace are retrieved. If a trace ending code, such as a tail pointer, or an off-trace branch is detected, the corresponding set, way, uop position, stew count, and head pointer of the trace are detected at operation 310. The next uop or group of uops in the trace is analyzed at operation 315 and checked at operation 320 for any uops violating an RTS build restriction, such as a micro-sequencer scoreboard uop. If a build restriction is violated, there cannot be an RTS and any trace information within the trace analyzer is cleared.

If no build restrictions have been violated, then uops are retrieved and analyzed according to the above steps until a loop prediction is encountered or the stew-based global prediction history saturates at operation 325. If a loop prediction is encountered or the stew-based global prediction history saturates, and no build restrictions have been violated (such as the RTS being longer than the space within the TRQ, denoted by the value “N”), then the trace must be part of an RTS and the corresponding reuse count is set to the loop count (denoted by the value “M”) and saved at operation 330. The reuse count is set to infinity if no loop prediction is available. The remaining uops within one iteration of the RTS are retrieved, then at operation 335, the trace analyzer indicates to the reuse controller that it may stream the trace from the TRQ.

Once an RTS is detected by the trace analyzer, and the LP hit or stew starts to repeat, it may send a signal to the reuse controller indicating this so that the reuse controller can set its start pointer in an appropriate location in the TRQ to store the RTS at operation 340. Once the end of the RTS is detected by the trace analyzer at operation 345, the trace analyzer provides the reuse controller with a signal indicating the end of the RTS at operation 350, the head pointer of the next uop to be referenced after the RTS is streamed from the TRQ, the loop count, and the reuse count. If the reuse count was set by the loop predictor, it may be reset such that the TRQ will transition control back to the trace cache upon the final iteration of the RTS. However, in another embodiment, if the reuse count was set by the MS ROM due to a repeated instruction that operates on a string of data, for example, then the reuse count will retain the count set by the MS ROM.

After the trace analyzer has enabled the reuse controller to stream the RTS according to the loop count, the trace analyzer may then disable the trace cache and branch prediction control unit, in some embodiments, in order to conserve power while the RTS is streamed from the TRQ.

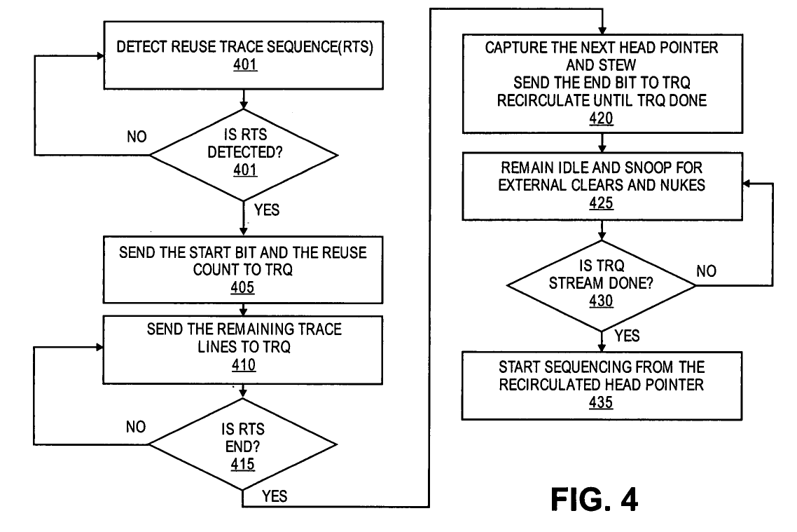

FIG. 4 is a flow diagram illustrating the transition to and from TRQ stream mode, according to one embodiment of the invention. After the RTS is detected at operation 401, a start signal and reuse count is sent to the TRQ at operation 405. In one embodiment the start signal is a bit or group of bits. The remaining uops within the trace are sent to the TRQ until the end of the RTS is detected at operations 410 through 415. At operation 420, the next head pointer in the trace cache is stored along with the loop count and the TRQ streams uops of the RTS at operation 425 until some event occurs that causes the write pointer to be redirected, such as a clear or nuke, occurs, or the TRQ stream ends. After streaming at operation 430, traces are issued from the trace cache at operation 435 beginning at the next head pointer saved earlier or any redirection due to nukes or clears.

Once the reuse controller receives a start signal from the trace analyzer, it controls the streaming of the RTS from the TRQ. The reuse controller receives a signal from the trace analyzer, which sets a write pointer to a location in the TRQ from which to begin storing the RTS. The write pointer can then advance as the RTS is stored to the TRQ until the RTS is stored. Once the RTS is stored, a read pointer, controlled by the reuse controller, propagates through the RTS stored in the TRQ as the uops are streamed there from. However, unlike prior art uop queue read pointers, that merely stop or wrap around at the end of the queue, the read pointer in one embodiment of the invention can wrap around to the start pointer when it encounters an end pointer.

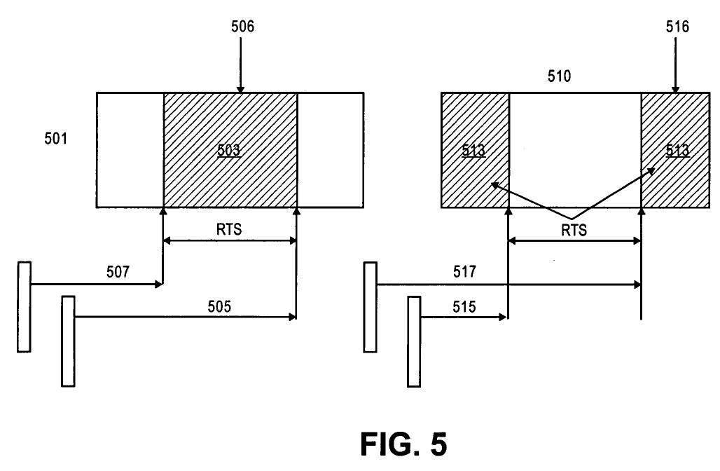

FIG. 5 illustrates the TRQ, according to one embodiment of the invention. Particularly, the TRQ 501 has space 503 allocated for an RTS defined by start pointer 505 and end pointer 507. During normal operation, in one embodiment, a read pointer 506 propagates through the RTS from the start pointer toward the end pointer as uops are streamed from the TRQ. Similarly, the TRQ 510 uses start pointer 515 and end point 517 to define the space 513 in which an RTS is to be stored. Read pointer 516 propagates not only to the end of the TRQ, but to the end pointer before wrapping around to the start pointer.

In both TRQ's illustrated in FIG. 5, the read pointer wraps around to the start pointer from the end pointer for each iteration of the RTS. If the reuse count is valid, the RTS is continuously streamed from the TRQ as the reuse count is decremented for each iteration until the count is exhausted. However, if the reuse count is not valid, in one embodiment, the TRQ is streamed until an event, such as a mispredict, nuke, or reset occurs.

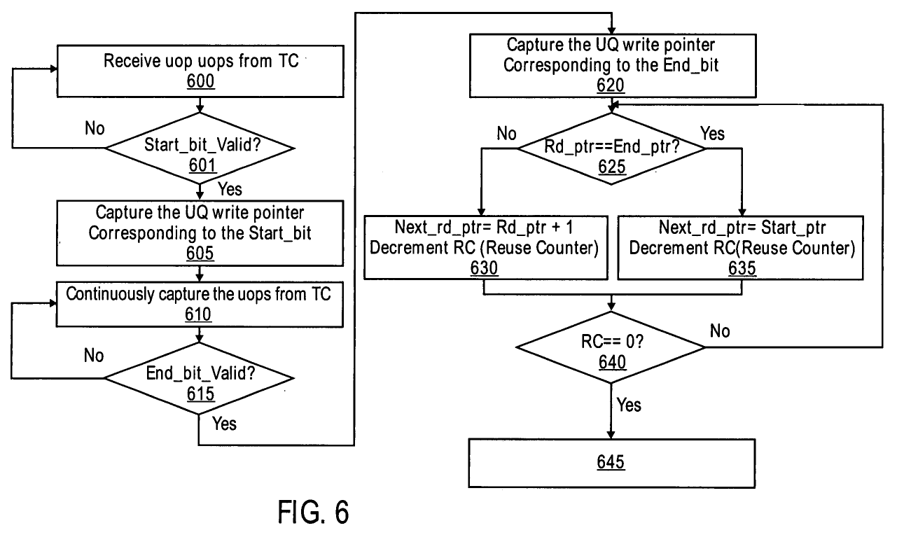

FIG. 6 is a flow diagram illustrating operations performed by the TRQ reuse controller, according to one embodiment of the invention. Until the reuse controller has received a start signal, such as a start bit, at operation 601, the reuse controller continues to receive uops of the RTS at operation 600. However, once the reuse controller has received the start bit, it receives the TRQ write pointer corresponding to the start bit from the trace analyzer at operation 605 and continually stores uops of the RTS into the TRQ starting from the start bit write pointer location at operation 610. After receiving an end signal, such as an end bit, from the trace analyzer at operation 615, the write pointer corresponding to the end bit is received by the reuse controller at operation 620.

After the RTS has been stored in the TRQ, the read pointer propagates through the TRQ from the start pointer to the end pointer and wraps around again until the read count is exhausted at operations 625 through 640. After the read count is exhausted, assuming it's valid, normal operation is resumed at operation 645.

During the time that uops of an RTS are streaming from the TRQ, circuits not involved in the streaming operation may be powered down to conserve power. In one embodiment, the trace cache, MS ROM, and branch prediction circuits may be disabled after an RTS is detected, as these circuits are not useful during the time when an RTS is streaming from the TRQ. In particular, branch prediction circuits are not useful during an RTS stream as they will always result in the same prediction during multiple iterations of an RTS. Therefore, the branch prediction control unit and other prediction circuits can be disabled in one embodiment of the invention. Furthermore, after RTS is retrieved from the trace cache or MS ROM, these circuits are no longer needed while the RTS is streamed from the TRQ. Therefore, the MS ROM and the trace cache can both be disabled in one embodiment during a time when an RTS is streamed from the TRQ.

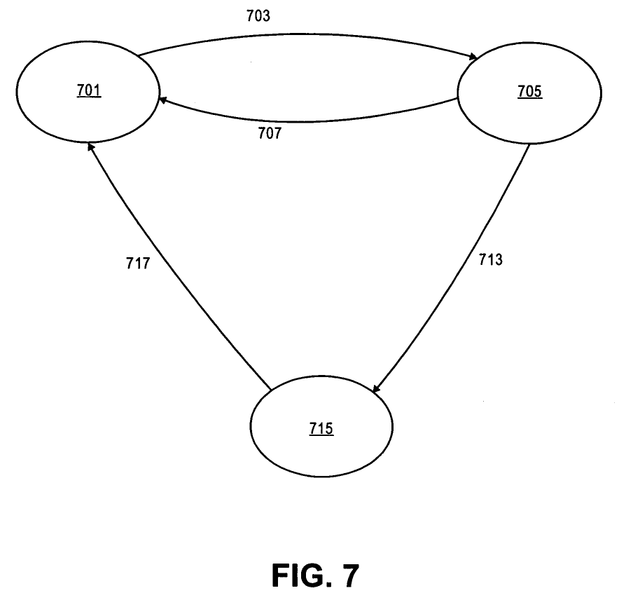

FIG. 7 is a state diagram illustrating various power modes that a trace management architecture may enter according to one embodiment of the invention. In normal mode 701, traces are being issued from the trace cache or MS ROM according to prediction algorithms implemented by the prediction circuitry. Upon a detection of an RTS and a loop prediction hit or slew-based prediction saturation, indicated by signal 703, the trace management architecture of one embodiment illustrates an autonomous mode 705 in which the trace cache, MS ROM and branch prediction circuits are all disabled, with the exception of circuitry for making prediction updates. Branch prediction updates may be made during the time when the RTS is being stored to the TRQ that may affect the flow of the uops within the RTS. Therefore, branch prediction updates are enabled while in autonomous mode. If a branch prediction update causes a branch outside the RTS, as indicated by signal 707, the trace management architecture embodiment will return to normal mode. However, in other embodiments the branch prediction update may not cause the trace management to return to normal.

However, once the RTS uops begin streaming from the TRQ, as indicated by signal 713, the trace management architecture embodiment can enter quiet mode 715, in which the trace cache, MS ROM, branch prediction and prediction update circuits are disabled, resulting in more power savings than in the autonomous mode state. Once the TRQ has finished streaming or some other event, such as a reset, nuke, or clear, occurs, as indicated by signal 717, normal operation may again resume.

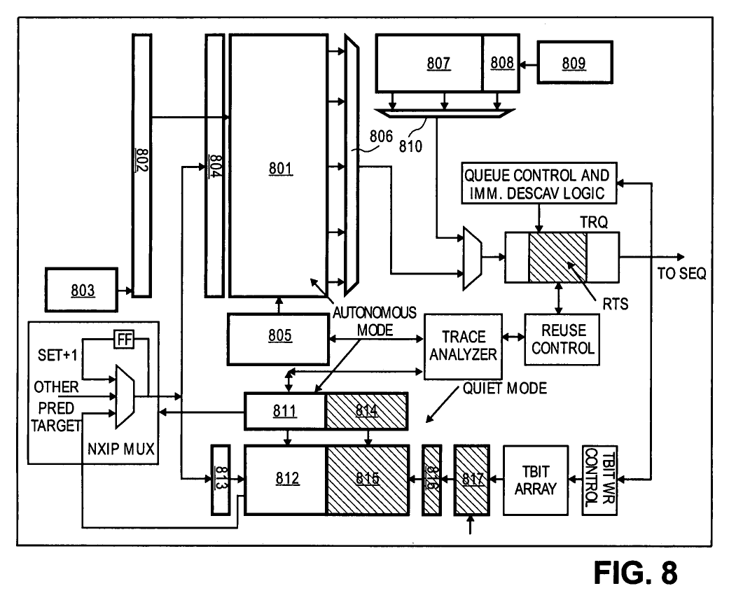

FIG. 8 is a block diagram of a trace management architecture, according to one embodiment, illustrating the circuits that may be powered down during each of the power management states illustrated in FIG. 7. During autonomous mode, the trace cache 801, including the trace cache fill buffer 802, trace cache fill buffer control 803, trace cache decode logic 804, trace cache control 805, and trace MUX 806 may be disabled. Furthermore, during autonomous mode, MS ROM 807, RAM 808, RAM/ROM control 809, and MS MUX 810 may be disabled. Likewise, some of the prediction circuits may be disabled during autonomous mode, including the trace branch prediction control unit 811, the prediction unit 812 and predictor decode logic 813.

During quiet mode, all circuits disabled in the trace management architecture of FIG. 8 during autonomous mode can be disabled, plus the trace branch prediction update control unit 814, the prediction update unit 815, update decoder 816, and trace branch information table (TBIT) read control unit 817. Accordingly, quiet mode can result in the most power savings of any of the power states illustrated in FIG. 7, according to one embodiment.

Embodiments of the invention may be implemented in a number of different semiconductor devices and/or computer systems in which instructions are decoded and used to perform various functions. Accordingly, the processors and systems disclosed herein are only examples of the devices and systems in which embodiments of the invention may be used.

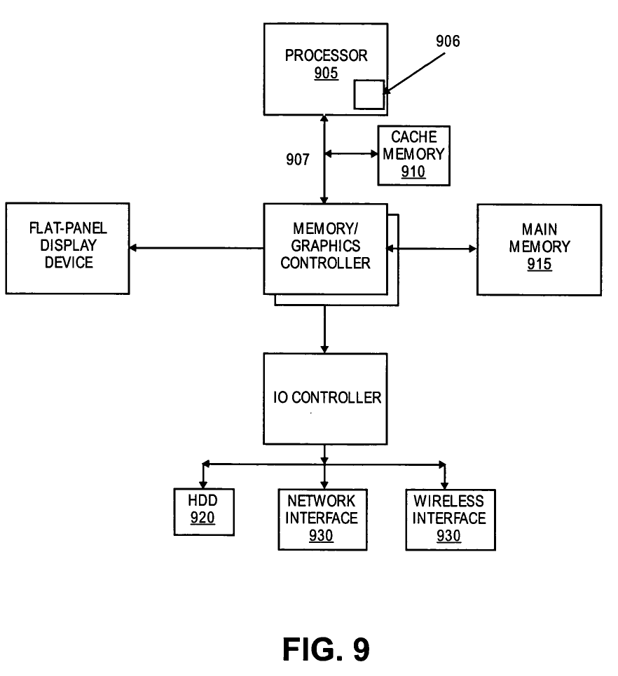

FIG. 9, for example, illustrates a front-side-bus (FSB) computer system in which one embodiment of the invention may be used. A processor 905 accesses data from a level one (L1) cache memory 910 and main memory 915. In other embodiments of the invention, the cache memory may be a level two (L2) cache or other memory within a computer system memory hierarchy. Furthermore, in some embodiments, the computer system of FIG. 9 may contain both a L1 cache and an L2 cache, which comprise an inclusive cache hierarchy in which coherency data is shared between the L1 and L2 caches.

Illustrated within the processor of FIG. 9 is one embodiment of the invention 906. Other embodiments of the invention, however, may be implemented within other devices within the system, such as a separate bus agent, or distributed throughout the system in hardware, software, or some combination thereof.

The main memory may be implemented in various memory sources, such as dynamic random-access memory (DRAM), a hard disk drive (HDD) 920, or a memory source located remotely from the computer system via network interface 930 containing various storage devices and technologies. The cache memory may be located either within the processor or in close proximity to the processor, such as on the processor's local bus 907. Furthermore, the cache memory may contain relatively fast memory cells, such as a six-transistor (6T) cell, or other memory cell of approximately equal or faster access speed.

The computer system of FIG. 9 may be a point-to-point (PtP) network of bus agents, such as microprocessors, that communicate via bus signals dedicated to each agent on the PtP network. Within, or at least associated with, each bus agent is at least one embodiment of invention 906, such that store operations can be facilitated in an expeditious manner between the bus agents.

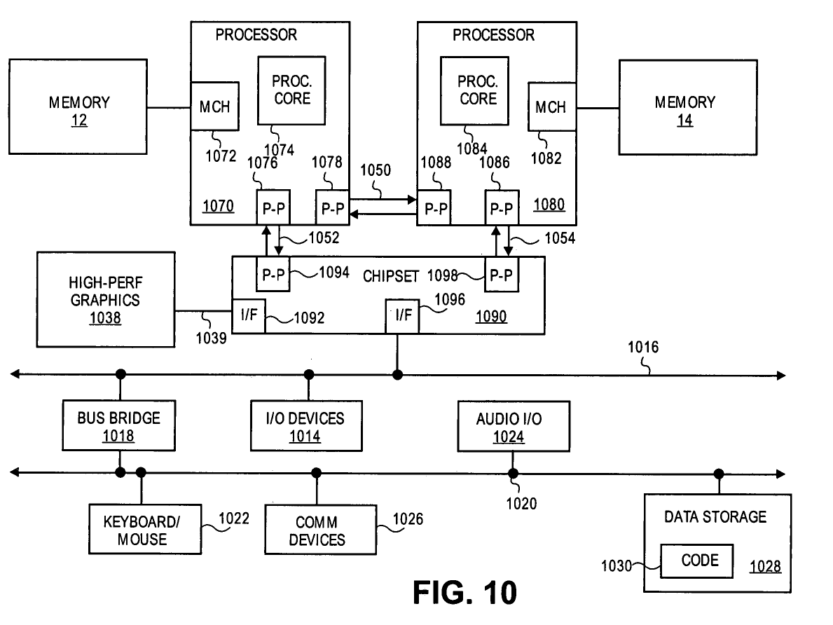

FIG. 10 illustrates a computer system that is arranged in a point-to-point (PtP) configuration. In particular, FIG. 10 shows a system where processors, memory, and input/output devices are interconnected by a number of point-to-point interfaces.

The system of FIG. 10 may also include several processors, of which only two, processors 1070, 1080 are shown for clarity. Processors 1070, 1080 may each include a local memory controller hub (MCH) 1072, 1082 to connect with memory 22, 24. Processors 1070, 1080 may exchange data via a point-to-point (PtP) interface 1050 using PtP interface circuits 1078, 1088. Processors 1070, 1080 may each exchange data with a chipset 1090 via individual PtP interfaces 1052, 1054 using point to point interface circuits 1076, 1094, 1086, 1098. Chipset 1090 may also exchange data with a high-performance graphics circuit 1038 via a high-performance graphics interface 1039.

At least one embodiment of the invention may be located within the PtP interface circuits within each of the PtP bus agents of FIG. 10. Other embodiments of the invention, however, may exist in other circuits, logic units, or devices within the system of FIG. 10. Furthermore, other embodiments of the invention may be distributed throughout several circuits, logic units, or devices illustrated in FIG. 10.

Embodiments of the invention described herein may be implemented with circuits using complementary metal-oxide-semiconductor devices, or “hardware”, or using a set of instructions stored in a medium that when executed by a machine, such as a processor, perform operations associated with embodiments of the invention, or “software”. Alternatively, embodiments of the invention may be implemented using a combination of hardware and software.

While the invention has been described with reference to illustrative embodiments, this description is not intended to be construed in a limiting sense. Various modifications of the illustrative embodiments, as well as other embodiments, which are apparent to persons skilled in the art to which the invention pertains are deemed to lie within the spirit and scope of the invention.

What is claimed is:

1. An apparatus comprising:
a trace cache to store a reusable trace;
a trace queue to store only one instance of the reusable trace and to issue micro-operations (uops) from the reusable trace a plurality of times before storing subsequent traces from the trace cache.

2. The apparatus of claim 1 further comprising a reuse controller to assign values to a start pointer corresponding to the beginning of the one instance of the reusable trace, an end pointer corresponding to the end of the one instance of the reusable trace, and a read pointer corresponding a uop to be issued from the trace queue.

3. The apparatus of claim 2 further comprising a trace analyzer to analyze the one instance of the reusable trace and to issue the reusable trace to the reuse queue.

4. The apparatus of claim 3 wherein the trace analyzer comprises a reusable trace detector to detect the reusable trace within the trace cache.

5. The apparatus of claim 4 wherein the trace analyzer comprises a reusable trace length detector to detect the length of the reusable trace within the trace cache.

6. The apparatus of claim 5 wherein the trace analyzer comprises a reusable trace build checker to detect a reusable trace policy violation during the creation of the reusable trace within the trace cache.

7. The apparatus of claim 6 further comprising prediction logic to predict branches within the reusable trace.

8. A system comprising:
a memory unit to store a loop of micro-operations (uops);
a processor to organize the loop of uops into at least one trace of sequentially executable uops, the processor comprising a uop queue from which to issue only one instance of the at least one trace a number of times that is no greater than the number of iterations of the loop.

9. The system of claim 8 wherein the at least one trace is stored in a trace cache from the only one instance of the at least one trace is to be issued to the uop queue.

10. The system of claim 9 wherein the processor is to organize the at least one trace according to a plurality of build criteria.

11. The system of claim 10 wherein the at least one trace comprises uops stored in a micro-sequencer read-only memory (MSROM).

12. The system of claim 11 wherein the processor includes prediction logic to predict whether branches will occur within the at least one trace according to a global branch prediction algorithm.

13. The system of claim 12 wherein the processor includes a trace analyzer to detect the at least one trace, store the at least one trace to the uop queue, and disable a first portion of the prediction logic and trace cache during a time in which the one instance of the at least one trace is issuing from the uop queue.

14. The system of claim 13 wherein the number of iterations of the loop is stored in a loop count that is decremented after each iteration of the loop.

15. The system of claim 14 wherein after the loop count is equal to either a value equal to the number of times a reuse trace sequence (RTS) is to be issued from the uop queue or a number of uops within the MSROM to be included in the RTS.

16. A method comprising:
issuing a plurality of uops within a reusable trace;
reducing power consumption or increasing a rate at which uops are executed in response to issuing the plurality of uops within the reusable trace;
increasing power consumption or decreasing a rate at which instructions are executed in response to the issuing being completed.

17. The method of claim 16 wherein the reducing power consumption comprises reducing power consumption to a first level in response to the reusable trace being stored to a micro-operations (uops) queue.

18. The method of claim 17 wherein the reducing power consumption comprises reducing power consumption to a second level in response to the reusable trace being streamed from the uops queue.

19. The method of claim 18 wherein the second level is less than the first level.

20. The method of claim 19 wherein the first level results from disabling a trace cache, a micro-sequencer, and a first portion of a branch prediction logic.

21. The method of claim 20 wherein the second level results from the disabling the trace cache, the micro-sequencer, the first portion of the branch prediction logic, and a second portion of the branch prediction logic.

22. The method of claim 21 wherein the first portion of branch prediction logic excludes a branch prediction update circuit.

23. The method of claim 21 wherein the second portion of branch prediction logic includes a branch prediction update circuit.

24. The method of claim 23 wherein the increasing power comprises enabling the trace cache, micro-sequencer, and the first and second portions of the branch prediction logic.

25. A processor comprising:
a first means for storing a reusable trace;
a second means for storing only one instance of the reusable trace and to issue micro-operations (uops) from the reusable trace a plurality of times before storing subsequent traces from the first means;
a third means for assigning values to a start pointer corresponding to the beginning of the one instance of the reusable trace, an end pointer corresponding to the end of the one instance of the reusable trace, and a read pointer corresponding a uop to be issued from the second means.

26. The processor of claim 25 further comprising a fourth means for analyzing the one instance of the reusable trace and to issue the reusable trace to the reuse queue.

27. The processor of claim 26 wherein the fourth means comprises a reusable trace detector to detect the reusable trace within the first means.

28. The processor of claim 27 wherein the fourth means comprises a reusable trace length detector to detect the length of the reusable trace within the first means.

29. The processor of claim 28 wherein the fourth means comprises a reusable trace build checker to detect a reusable trace policy violation during the creation of the reusable trace within the first means.

30. The processor of claim 29 further comprising fifth means for predicting branches within the reusable trace.
